(19) United States
(12) Patent Application Publication
(10) Pub. No.: US 2006/0294283 A1
(43) Pub. Date: Dec. 28, 2006

(54) Universal Serial Bus Device

(75) Inventor: King Mo Tong, Kowloon (CN)

Correspondence Address: SHELDON MAK ROSE & ANDERSON PC, 225 SOUTH LAKE AVENUE, 9TH FLOOR, PASADENA, CA, 91101, US

(73) Assignee: SINOTEC INTERNATIONAL CO. LTD., Kowloon (CN)

(21) Appl. No.: 11/426,260

(22) Filed: Jun. 23, 2006

(30) Foreign Application Priority Data
Jun. 25, 2005 (CN) 200510082390.2

(51) Int. Cl. G06F 13/00

(52) U.S. Cl. 710/304

(57) ABSTRACT

A universal serial bus device capable of automatically executing a designated program is provided, comprising a housing, a universal serial bus interface, a printed circuit board, and one or more EEPROM memory devices, wherein the printed circuit board, the universal serial bus interface and the EEPROMs are electrically connected and powered by the universal serial bus interface. In this device, the printed circuit board is provided with an integrated circuit thereon and a data terminal of each of the EEPROMs is connected correspondingly to an input/output terminal of the integrated circuit; a control terminal of each of the memories is connected correspondingly to a control terminal of the integrated circuit; a communication terminal of the integrated circuit is connected to the universal serial bus interface; and the integrated circuit is loaded with a program for automatically executing instructions.

The present application claims priority from Chinese Patent Application No. 200510082390.2, filed on Jun. 25, 2005, the entire disclosure of which is hereby incorporated by reference.

### BACKGROUND

An internet website is typically accessed by inputting a series of letters constituting the website's address with a keyboard. The internet itself is unable to confirm whether or not a particular website address is being accessed, nor does it perform the function of filtering. When a user forgets the website address or inputs an incorrect website address, he or she has no way to connect to the relevant website.

### SUMMARY

The present invention addresses this problem by providing a universal serial bus device, in particular, a universal serial bus device that stores user identifications (ID's) and user passwords for accessing a website. The device can automatically execute a program stored on the device and can be used as a website key for the internet.

A universal serial bus device according to the present invention preferably comprises a housing, a universal serial bus interface, a printed circuit board, and one or more memory storage components, such as electrically erasable programmable read-only memory (EEPROMs). The printed circuit board, universal serial bus interface, and memories are electrically connected to and powered by a universal serial bus. The printed circuit board is provided with an integrated circuit thereon, and a data terminal of each of the memories is connected to a corresponding input/output terminal of the integrated circuit. A control terminal of each of the memories is connected to a corresponding control terminal of the integrated circuit, and a communication terminal of the integrated circuit is connected to the universal serial bus interface.

Programs are stored in the memory storage components. Such programs can include a mapping program that maps a part of the memory space of one or more memory storage components as a read-only memory (ROM) portion of the memory storage components, and a program for controlling the integrated circuit's read/write functions, which can be stored for example in ROM. In addition, a program for automatically executing a set of instructions is also stored in the ROM.

The memories of the present universal serial bus device are preferably EEPROMs, and more preferably are flash EEPROMs. Each of the EEPROMs also preferably has a capacity of between about 2 kilobytes and 16 kilobytes. In one embodiment, the device comprises a single 16 kilobyte EEPROM. Optionally, The ROM of the present device can be a CD-ROM.

Within the universal serial bus device according to the present invention, the program for automatically executing a set of instructions can be a program for accessing a website. Alternatively or in addition to this, the device can comprise a program for automatically executing a set of instructions that provides an independent user ID or user password.

When a user of the present device connects the device to a universal serial bus port of a computer, the programs stored in the ROM will be executed automatically if the computer's operating system supports an industry standard universal serial bus interface driver, such as, for example, the Windows 2000®, Windows ME®, or Windows XP® operating systems, sold by Microsoft® Corporation.

As compared with the prior art, the present universal serial bus device, in one embodiment, uses a program for automatically executing a set of instructions, a user ID and a user password that function together to access a website. The program for automatically executing a set of instructions, the user ID and the user password can be stored in the ROM of the device, and each time the user connects the device to the universal serial bus port of the computer, the computer operating system will execute the set of instructions stored on the device to directly and automatically link to the website and enter the linked website using the user ID and the user password. Since the present device uses a USB, it acquires power from the power supply of the computer utilizing the universal serial bus, so that it need not have an independent power supply, making the device portable and easy to operate

The internet can thus be accessed using the universal serial bus device of the present invention without a search engine or emulator. An accessed website can also be shown or not shown, depending on the nature of a transaction occurring on the website.

### DRAWINGS

These and other features, aspects and advantages of the present invention will become better understood with regard to the following description, appended claims, and accompanying figures.

FIG. 1 is a structural diagram of the circuit of the universal serial bus device of the present invention.

All dimensions specified in this disclosure are by way of example only and are not intended to be limiting. Further, the proportions shown in these figures are not necessarily to scale. As will be understood by those with skill in the art with reference to this disclosure, the actual dimensions of any device or part of a device disclosed in this disclosure will be determined by their intended use.

### DESCRIPTION

Universal Serial Bus Interface Device

With the increased use of universal serial bus memory storage components and other universal serial bus devices such as, for example, a computer keyboard, that are attached to computers, a website key such as the present universal serial bus device can obviate the need for a user to memorize every website address, the user's ID and the user's password in order to access a website. By using such a website key, incorrect websites are not accessed. Each website key can have an independent identification number embedded therein and can be identified and tracked by the website that the user accesses.

The operation of such website keys is fairly simple. First, the website key is inserted into a universal serial bus port of a computer. Then, the computer operating system can automatically identify the website key by the user ID and user password stored therein. Optionally, the website key can use a memory driver or CD driver in the system to read the contents stored in this memory or CD. The system then automatically links to the website designated by the website key.

The universal serial bus device according to the present invention comprises a universal serial bus interface, memories 20, and a printed circuit board. The universal serial bus device is powered by the computer's universal serial bus.

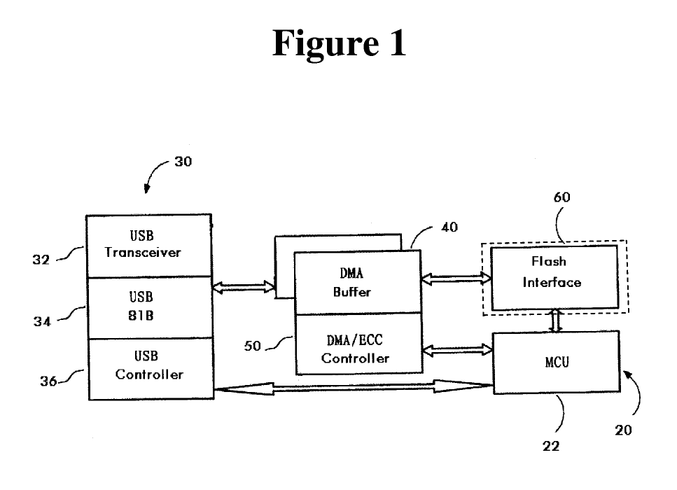

FIG. 1 shows the circuit structure of an embodiment of the present universal serial bus device which is capable of automatically executing a designated program. As shown in FIG. 1, the USB connector 34 and the memories are electrically connected. The integrated circuit 30 of the universal serial bus device comprises a universal serial bus transceiver 32, a universal serial bus connector 34 and a universal serial bus controller 36, which are electrically interconnected. The universal serial bus connector 34 is connected to one or more memory storage components 20, such as memory control unit (MCU) memories 22, which are under the control of the universal serial bus controller 36 and a direct memory access/error checking and correcting (DMA/ECC) controller 50 using a direct memory access (DMA) buffer 40 and an optional flash interface 60. The data terminal of the memories 20 is electrically connected to an input/output terminal of the integrated circuit 30, and a control terminal of the memories 20 is connected correspondingly to a control terminal of the universal serial bus controller 36.

In one embodiment, the following programs are stored in the integrated circuit 30: (1) a mapping program for mapping a part of the memory space of the memories 20 as read-only memory (ROM); (2) a program for automatically executing a set of instructions for accessing a website address that is stored in the EEPROMs of the memories 20; and (3) a program for controlling reading/writing operations on the memories 20. The program for automatically executing a set of instructions can provide a user ID or a user password, whereby the computer operating system directly and automatically connects to a desired website.

In one embodiment, the number of the memories 20 can be one, and such memory can be either an EEPROM or a CD-ROM. EEPROMs used with the present device preferably have a capacity of between 2 kilobytes and 16 kilobytes. In addition, the universal serial bus device of the present invention can be further connected to other peripheral auxiliary devices, including a power rectifier, a low voltage detector and a phase locked loop of 12-48 MHz.

In the process of manufacturing the present USB interface device, when the program files for automatically executing instructions are stored in a read-only memory such as, for example, a CD-ROM, it is unnecessary to set up any other drivers if the computer's operating system supports an industry standard universal serial bus interface driver, such as, for example, the Windows 2000®, Windows ME®, or Windows XP operating systems, made by Microsoft® Corporation.

Upon the automatic execution of the program by the computer, a website can be linked to using the universal serial bus device of the present invention. At the same time, using the user ID and user password stored in the universal serial bus device, the user's ID can be recorded on the website to which the user is connected.

In operation, the present universal serial bus device connects to a website as follows. The device is first connected to a computer, for example a computer using the Windows XP® operating system made by Microsoft® Corporation, which then reads the program files for automatic execution stored in the MCU 22. The automatically executed program then reads the stored preset user ID and user password and the website address to be connected to, for example, in the flash interface 60 (the preset user ID and user password and website address to be connected to may also be stored in the MCU 22, and therefore the flash interface 60 is optional). The computer operating system then connects to the website.

The USB interface device of the present invention can be used with computer systems in various situations, including in stores, banks, and supermarkets. The device can also be used by network administrators, for example for membership administration, video program administration, and software products administration.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure. All references cited herein are incorporated by reference to their entirety.

What is claimed is:

1. A universal serial bus device capable of automatically executing a designated program, comprising:
(a) a universal serial bus interface;
(b) a printed circuit board provided with an integrated circuit thereon, the integrated circuit comprising a communication terminal connected to the universal serial bus interface and an input/output terminal; and
(c) one or more memory storage components electrically connected to the universal serial bus interface, each of the one or more memory storage components comprising a data terminal connected to an input/output terminal of the integrated circuit and a control terminal connected to a control terminal of the integrated circuit, wherein the following programs are stored in the one or more memory storage components:
(i) a mapping program which maps a part of the memory space of at least one of the memory storage components as read-only memory,
(ii) a program for automatically executing instructions loaded in the read-only memory; and
(iii) a program for controlling reading/writing onto the one or more memory storage components.

2. The universal serial bus device of claim 1, wherein the one or more memory storage components comprises an EEPROM.

3. The universal serial bus device of claim 2, wherein the EEPROM has a capacity of between 2 kilobytes and 16 kilobytes.

4. The universal serial bus device of claim 1, the wherein the one or more memory storage components comprises a flash EEPROM.

5. The universal serial bus device of claim 1, wherein the one or more memory storage components comprises a CD-ROM.

6. The universal serial bus device of claim 1, wherein the one or more memory storage components comprises a single EEPROM.

7. The universal serial bus device of claim 1, wherein the program for automatically executing instructions is a program for linking to a website.

8. The universal serial bus device of claim 7, wherein the program for automatically executing instructions provides an ID or password.

9. The universal serial bus device of claim 1, further comprising a housing for the device.

10. A universal serial bus device capable of automatically executing a designated program, comprising:
(a) a universal serial bus interface;
(b) a printed circuit board provided with an integrated circuit thereon, the integrated circuit comprising a communication terminal connected to the universal serial bus interface and an input/output terminal; and
(c) one or more EEPROMs electrically connected to and powered by the universal serial bus interface, each of the one or more EEPROMs comprising a data terminal connected to an input/output terminal of the integrated circuit and a control terminal connected to a control terminal of the integrated circuit, wherein the following programs are stored in the one or more memory storage components:
(i) a mapping program which maps a part of the memory space of at least one of the memory storage components as read-only memory,
(ii) a program for automatically executing instructions loaded in the read-only memory; and
(iii) a program for controlling reading/writing onto the one or more memory storage components.
